(19) United States
(12) Patent Application Publication
(10) Pub. No.: US 2004/0083205 A1
(43) Pub. Date: Apr. 29, 2004

(54) Continuous knowledgebase access improvement systems and methods

(76) Inventor: Steve Yeager, Rocklin, CA (US)

Correspondence Address: HEWLETT-PACKARD COMPANY, Intellectual Property Administration, P.O. Box 272400, Fort Collins, CO, 80527-2400, US

(21) Appl. No.: 10/282,353

(22) Filed: Oct. 29, 2002

(51) Int. Cl. G06F 7/00

(52) U.S. Cl. 707/3

(57) ABSTRACT

A method for continuous knowledgebase content access improvement comprises receiving a search string and resultant search results of the knowledgebase content, establishing whether a valid result matches the search string, and increasing weighting of matching valid search result content.

### FIELD OF THE INVENTION

The present invention is generally related to search engines and the like and particularly to continuous knowledgebase access improvement systems and methods.

### DESCRIPTION OF RELATED ART

There are numerous existing search technologies related to knowledgebase searches that attempt to rank knowledge representation of content by keyword match strength, concept matching and/or categorization algorithms. These existing algorithms employ a static state of the structure of the underlying data. There are some technologies that have an ability to “tune” content based on popularity of incoming search queries. The current standard model for support content, particularly documents relating to repair or issues and solutions, is to author documents without knowledge of just how a search user will actually phrase searches for the content, or to author content from a list of issues resolved elsewhere. Other solutions are based on a model of making as much data available as possible and leaving the customer to find what he or she is looking for in what may be a vast quantity of data. Problematically, these existing solutions do not monitor what search users are looking for and provide improved access to that content accordingly. Also, existing solutions do not prompt authorship of new content to meet user needs. There is no existing automated process for analyzing search queries and suggesting how to create linkages between queries and content. Also, there are no existing automated processes for content weighting based on frequency of customer views combined with modification of the original document with the addition of supplemental metadata used to improve future searches.

PRIMUS® search technology allows manual addition of statements related to a user's search queries to content. This allows for unrelated statements to be appended to a piece of content that might improve its ranking during execution of a search query. This existing process is manual and reliability is based on usage of the tool.

SOFFRONT™ Knowledge Management is an existing support knowledgebase solution that has a “usefulness” metric employed to help select content from its knowledgebase and re-rank this selected content based on how many times a solution is viewed.

KNOWLEDGE™ Management Software has products that rely on content usefulness. This existing product does not have any processes for suggesting knowledge creation, but does provide methods for increasing the relevancy of content based on usage patterns.

Existing passive search technologies include search engines such as GOOGLE®, ALTA VISTA®, AUTONOMY®, VERITY®, and the like. These technologies typically rely on complex word relationships in ranking content and typically do not employ a content improvement process. These search engines typically analyze a static set of content and based on internal algorithms, determine a ranking of content. Some existing search engines employ statistical analysis of what content is most frequently viewed, but typically do not employ processes for both content improvement and addition of new metadata into a solution. Particularly, existing search engines do not provide systems and methods for strengthening weighting of a particular piece of content to increase its relevancy.

### BRIEF SUMMARY OF THE INVENTION

An embodiment of a method for continuous knowledgebase content access improvement comprises receiving a search string and resultant search results of the knowledgebase content, establishing whether a valid result matches the search string, and increasing weighting of matching valid search result content.

An embodiment of a system for continuous knowledgebase content access improvement comprises means for decaying relevance of content of a knowledgebase by reducing weighting of each piece of the content at regular time increments, and means for adjusting the relevance by increasing the weighting of valid content returned as matching a search string submitted to the knowledgebase.

Another embodiment of a method for knowledgebase access improvement comprises searching a knowledgebase, searching results from said knowledgebase search for additional data related to relevancy of said results to said knowledgebase search, determining relevance of said knowledgebase search results based, at least in part, on results of said search for additional data, and adjusting linkage strength of relevant knowledgebase search result content.

### BRIEF DESCRIPTION OF THE DRAWINGS

FIG. 1 is a flowchart of an embodiment of the present continuous knowledgebase access improvement method;

FIG. 2 is a diagrammatic illustration of an embodiment for increasing linkage between a solution set and search parameters concurrent with content aging in accordance with the present invention;

FIG. 3 is a diagrammatic illustration of an embodiment of the present continuous knowledgebase access improvement systems; and

FIG. 4 is a diagrammatic flowchart of an alternative embodiment of the present methods employed as a secondary search in conjunction with a search engine or the like.

### DETAILED DESCRIPTION

The present invention is directed to systems and methods which provide continuous knowledgebase access improvement. The present invention enables improved searching of a knowledgebase and preferably facilitates restructuring of the data in the knowledgebase so that over time more useful data is presented first, above “noise” data that is typically accumulated within a knowledgebase. The present invention preferably makes a determination of what data is important and what data is not important and facilitates making important data more readily available for future searches.

As used herein, a knowledgebase is a database or set of data that contains issues/solution documents, break/fix documents and/or similar files, related to a product, service or the like. Any collection of data may be considered a knowledgebase. Oftentimes, a knowledgebase is related to a specific topic of interest, such as an area of science, technology or history. A knowledgebase typically employs a search and retrieval function of some sort. A solution is preferably provided in the form of an answer to a user's question or other search query.

Preferably, the present systems and methods match user search strings with solutions and employ content weighting based on content consumption. Content, that is viewed most frequently preferably receives increased weighting to increase the search relevancy of that particular piece of content for future searches. Content that is viewed infrequently is preferably subject to decay and targeted for obsolescence when a threshold is met. Thus, a future search has a more accurate return of useful element results. Whereas frequency of customer views may be an indicator of content usefulness, the present systems and methods employ a usefulness feature for self-learning and ranking of a piece of content. Also, embodiments of the present invention provide suggestions for authoring of new content and provide for addition of metadata to text of a solution to improve accuracy of future searches. Such metadata may be in the form of text derived from the text of the search string, or information about the specific user that submitted the search string. Such information might include the user's geographic location, language preference, or any other data that may be known or discernable about the user.

The present systems and methods are preferably complementary to passive search technologies such as the aforementioned search engines. The present invention adds an ability for content to ascend search result lists or decay based on usage statistics and the addition of metadata to a solution thereby improving future matches. The present invention preferably promotes the authoring of documents as they are needed, based on search user requests. Thus, over time more specific and accurate results are made available to knowledgebase users.

The present systems and methods provide a manner of managing support content in a knowledgebase with continuous improvement of the stored data. The present invention enhances the accuracy and relevance of the “hits” generated by a search engine and preferably ensures that content creation is carried out to meet the needs of customers who are requesting information from a knowledgebase.

Embodiments of the present systems and methods employ a plurality of different levels of analysis of an input search and the results therefrom. Preferably, the validity of the search string, or search query is analyzed against the results returned. One level of analysis is made as to whether or not a search comes back with “noise”. Noise is search results that do not have any documents relevant to the search query. Such noise is preferably not considered in the present analysis. At another level of analysis a valid search where no results set is available may invoke a suggestion back into the database, to an administrator or the like, that new content needs to be authored to address the topic(s) of the search query. Another analysis category is a valid search where a result set is available but no match is made. In accordance with the present invention, when results fall into this category, an addition of metadata to content may be employed to increase relevancy of the search string. Yet another category of analysis may result when valid searches have result sets available for use, particularly where a match has been made and accurate, responsive content was found. In such a case, relative weighting of the content is preferably strengthened.

FIG. 1 is a flow chart of embodiment 100 of the present knowledgebase search analysis and improvement method. The present process starts at 101 when a search string is received by the knowledgebase. Searches against the knowledgebase and the results are preferably captured, analyzed and classified into one of several categories. Following execution of the search string, a first decision is made at 102 as to whether or not the search string is valid. A search string may be declared invalid when either too little data content or only invalid content is returned by the search. Such content is considered noise and does not contain any sort of valid answers (box 1001). Noise is a search result set that can not return relevant documents. For noise, no further analysis is required by the present invention in such a case, as indicated at 103. A user not selecting any of the returned results may be an indication that a search string is invalid and returns only noise. Additionally or alternatively, the user might be polled as to whether the returned results were valid. A negative indication might be used to identify the results as noise.

A valid search with no result set available is a search result set that should have found content to match the search parameters, but no result set is available, as may be indicated by no results being returned. These null results may be flagged by the present systems and methods for later human review. Alternatively or additionally, these results may also be reviewed through an algorithm that may include expansion of the search terms, or a best fit algorithm capable of expanding the search results. For this category, new solutions are preferably authored so that future searches with similar parameters match the newly authored solutions. To this end, if the search string is found to be valid at 102, such as may be indicated by the user, either by a click on a returned result, or by a polling of the user, a determination as to whether or not valid results were returned from the search engine is made at 104. If valid results were not returned from the search engine, no solution is available at 1002, a suggestion that a new solution needs to be authored is preferably returned to the knowledgebase, preferably to an administrator or the like, at 105. This suggestion that new content be authored may take the form of issuance of an automatic email, an instant message or the like, to a person or entity responsible for content in the knowledgebase.

If a valid result set is returned in response to the search string, as determined at 104, a determination whether or not a match is made between the search and the result is preferably made at 106. A valid search with a result set available, but with no matches made, are searches where the search string is valid; there is a result set in the knowledgebase that should have been available, but no match was returned. For this search category, translation tables are preferably utilized to assist in matching of the solutions that should have matched the given search parameters. If a match is not made at 106 a solution may still be available even though no match is made, 1003. The relevancy of result content is preferably adjusted by adding metadata into translation tables of the content at 107. As indicated by way of example at box 108 that metadata may take the form of the text of the search string query itself. As a result text in that solution, and/or its translation tables, would match a similar future search string more closely. Thereby, the next time a search is carried out, a match, not only to the substance of the content may be made, but also to the metadata of the content translation tables. Thus, the content should be returned as a closer, or higher ranked search result.

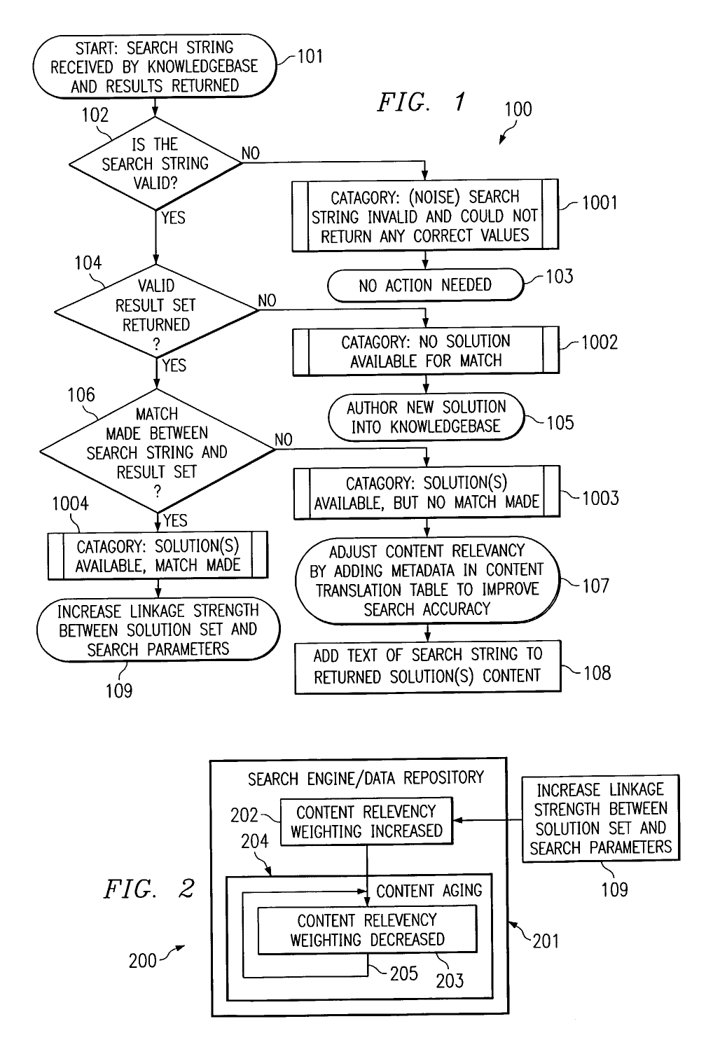

For a valid search with a result set available and matches made, linkage between the search string phrase and the result set is preferably strengthened. When it is established that a match is made at 106 and a valid result set was returned at 1004, weighting of the search solution that was returned is preferably increased at 109 so the next time a search result includes that solution it is presented higher on the list of results. An embodiment of this weighting at 109 to increase linkage strength between the solution(s) and search parameters is shown in greater detail in FIG. 2 and described below.

FIG. 2 is a diagrammatic illustration of content improvement and aging process 200 in accordance with an embodiment of the present invention. Content improvement and aging process 200 preferably takes place within a search or data repository or supplemental index that exists along with a knowledgebase or data repository 201. Process 200 preferably carries out step 109 of FIG. 1 to adjust linkage strength between a solution and search string parameters. Feedback may be provided from step 109 of FIG. 1 as shown. Relative content weighting attached to a returned matching solution is preferably increased at 202. Thus, overall relevancy of that particular solution to the given search string is preferably enhanced. Decay function 203 is employed as part of content aging process 204 such that over time the overall weighting of a particular piece of content will begin to decay and move the piece of content to a lower overall priority. Repetition of aging process 204 as indicated by arrow 205 should facilitate culling a database of irrelevant information, over time. Thus, over time content that is being used very frequently would accumulate weighting at 202 resulting in that content moving to a top of search result lists or the like, whereas weighting of content that is not used very often would decay at 204 causing that content to flow to the bottom of search result lists. Aging may be carried out, by way of example, on a daily or weekly basis. Thus, the weighting of content is constantly decaying at a minimal rate, but every time a hit against a piece of content results in use of the content, that content has weighting added at 202 reversing the decay at 203.

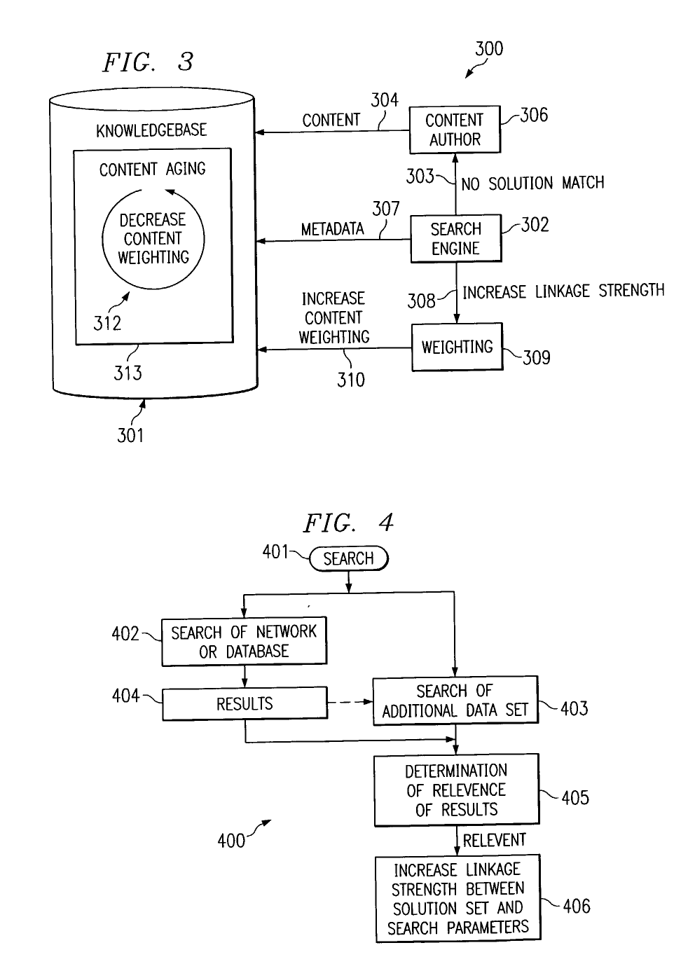

An embodiment of the present knowledgebase search analysis and improvement system 300 shown in FIG. 3 employs the above described method for continuous knowledgebase access improvement. Searches are preferably carried out by search engine 302 against knowledgebase 301. The results are preferably captured, analyzed and classified as detailed above. For a valid search with no result solution set match 303, new solution content 304 is preferably authored by content author 306 in such a manner that future searches with similar parameters match the newly authored solution. For searches where the search string is valid and results should be available, but no match was returned, the relevancy of result content is preferably adjusted by adding metadata 307 as described above in relation to step 107 of FIG. 1. For a valid search with a result set available and matches made, linkage between the search string phrase and the result set is preferably strengthened at 308. Relative content weighting 309 attached to a returned matching solution is preferably increased in knowledgebase 301, via weighting function 310. Decay function 312, part of content aging process 313 may be periodically carried out within knowledgebase 301 in accordance with content improvement and aging process 200, illustrated in FIG. 2 and described above.

Weight may be added to content based on criteria such as clicks, or user input as to the validity and usefulness of the content. When a user clicks, or selects, a solution, weighting may be increased. For example, choice of a fifth out of twenty listed solutions would preferably indicate that the selected solution was relevant and valid and the weighting is preferably increased for that solution, such that over time the solution would move up the list for the same search. Alternatively, a query of the user, preferably at the end of the user's experience with a document from the knowledgebase, may be used to determine whether or not a particular viewed piece of content was relevant and valid to solution of an issue. If it was relevant and valid, then weighting for the content may be increased. Time spent viewing content may also affect weighting of that content. Each weighting event, click, survey and time are preferably assigned a different level of importance affecting the degree of resultant weighting. For example, a survey may be considered relatively important, with a click maybe being secondarily important and time spent viewing content even less important, because time on a web page may be affected by a user's concentration or attention level.

Alternatively, some manual human analysis of the data with adjustment of the weighting and adjustment of metadata attached to a content element may be employed. This allows the content to either rise on search result lists or to obsolete itself off of the knowledgebase database.

Turning to FIG. 4, application of the present invention may not be limited to a single search engine, the present systems and methods may be employed as an additional feature or search function 400 built into or working in concert with search engine searches, or the like, to provide additional weighting. To facilitate a search of a database or network initiated at 401 and preferably carried out at 402 by a search engine, an additional data set may be provided in accordance with the present invention for parallel searching at 403. This additional data set may include relevancy weighting or metadata added to content in accordance with the present invention. The secondary search at 403 may be carried out by a second or secondary search engine that makes a determination at 405 of the importance of initially returned data 404. At 406, linkage strength between relevant data returned by the searches and the search string may be increased in accordance with the present invention, such as described in relation to 109 above, such as by increasing weighting of returned content.

As a further example, a user searching a database at 402, using a search engine that searches and ranks data using weighting in accordance with the present invention, could also employ a supplemental search tool at 403 to look at metadata earlier added to solutions in accordance with the present invention. The metadata may be used to determine additional significance of search results at 405. This usefulness data may be used to increase the linkage strength at 406 between the relevant data that was returned by the search, in accordance with the present invention such as described in relation to 109 above, thereby raising, or lowering, list ranking of particular content.

What is claimed is:

1. A method for continuous knowledgebase content access improvement comprising:
receiving a search string and resultant search results of said knowledgebase content;
establishing whether a valid result matches said search string; and
increasing weighting of matching valid search result content.

2. The method of claim 1 wherein said establishing further comprises analyzing said search results to determine if said search string is valid.

3. The method of claim 2 wherein said establishing further comprises determining whether a valid search string returned valid results.

4. The method of claim 1 further comprising reducing said weighting of said knowledgebase content at regular time increments.

5. The method of claim 1 further comprising adding metadata into unmatched valid search result content.

6. The method of claim 5 wherein said metadata is text of said search string.

7. The method of claim 5 wherein said metadata is added into a translation table of said content.

8. The method of claim 1 further comprising suggesting new content be authored in response to invalid results from a valid search string.

9. The method of claim 8 wherein said suggestion is made to an entity responsible for content in said knowledgebase.

10. The method of claim 1 wherein said establishing step comprises monitoring usefulness of said valid search results.

11. The method of claim 10 wherein said usefulness is based, at least in part, on at least one criteria selected from a group of criteria consisting of:
clicks on a valid search result;
time spent viewing a valid search result;
repeated clicks on a valid search result;
surveys about the usefulness of a valid search result completed by users; and
statistical sampling measuring quality of said content relative to said search string.

12. A system for continuous knowledgebase content access improvement comprising:
means for decaying relevance of content of a knowledgebase by reducing weighting of each piece of said content at regular time increments; and
means for adjusting said relevance by increasing said weighting of valid content returned as matching a search string submitted to said knowledgebase.

13. The system of claim 12 wherein said adjusting means further comprises means for receiving a search string and resultant search results of said knowledgebase content.

14. The system of claim 13 wherein said adjusting means further comprises means for analyzing said search results to determine if said search string is valid.

15. The system of claim 14 wherein said adjusting means further comprises means for determining whether a valid search string returned valid results.

16. The system of claim 12 further comprising means for adding metadata into unmatched valid search result content.

17. The system of claim 16 further wherein said metadata comprised text of said search string.

18. The system of claim 16 wherein said metadata is added into a translation table of said content.

19. The system of claim 12 further comprising means for suggesting new content be authored in response to invalid results from a valid search string.

20. The system of claim 19 wherein said suggestion is made to an entity responsible for content in said knowledgebase.

21. The system of claim 12 further comprising means for monitoring usefulness of said valid search results.

22. The system of claim 21 wherein said usefulness is based, at least in part, on at least one criteria selected from a group of criteria consisting of:
clicks on a valid search result;
time spent viewing a valid search result;
repeated clicks on a valid search result;
a survey about the usefulness of a valid search result completed by a user; and
statistical sampling measuring quality of said content relative to said search string.

23. A method for knowledgebase access improvement comprising:
searching a knowledgebase;
searching results from said knowledgebase search for additional data related to relevancy of said results to said knowledgebase search;
determining relevance of said knowledgebase search results based at least in part on results of said search for additional data; and
adjusting linkage strength of relevant knowledgebase search result content.

24. The method of claim 23 wherein said additional data related to relevancy comprises content weighting.

25. The method of claim 23 wherein said additional data related to relevancy comprises metadata.

26. The method of claim 25 wherein said metadata comprises text of earlier search strings.
